(19) United States
(12) Patent Application Publication
(10) Pub. No.: US 2018/0307997 A1
(43) Pub. Date: Oct. 25, 2018

(54) SYSTEMS AND METHODS FOR IMPROVED QUANTIFICATION OF UNCERTAINTY IN TURBOMACHINERY

(71) Applicant: General Electric Company, Schenectady, NY (US)

(72) Inventors: Ernesto Heliodoro Escobedo Hernández, Queretaro (MX); Jose Leon Vega Paez, Queretaro (MX)

(21) Appl. No.: 15/492,887

(22) Filed: Apr. 20, 2017

(51) Int. Cl. G06N 7/00; F01D 21/00; G01M 15/14; G01M 15/02; G06N 5/04

(52) U.S. Cl. CPC G06N 7/005; F01D 21/003; G01M 15/14; F05D 2220/32; G06N 5/04; F05D 2220/31; G01M 15/02

(57) ABSTRACT

A system includes a processor configured to retrieve a sensor data, wherein the sensor data comprises one or more signals communicated from a plurality of sensors disposed in a power production system. The processor is further configured to group the sensor data into a first bin of data based on a degradation measure. The processor is additionally configured to quantify an uncertainty in the one or more bins of data, wherein the uncertainty comprises a difference between the one or more bins of data and a corrected data variation inference.

### BACKGROUND OF THE INVENTION

The subject matter disclosed herein relates to operations, and more specifically, to systems and methods for quantification of uncertainty in turbomachinery.

Machine systems, including turbomachine systems, may include a variety of components and subsystems participating in a process. For example, a turbomachine may include fuel lines, combustors, turbine system, exhaust systems, and so forth, participating in the generation of power. The components and subsystems may additionally include sensors suitable for monitoring various operations. Data received from the sensors may include certain amount of uncertainty, for example, because of noise. Accordingly, it would be beneficial to quantify uncertainty, for example, in sensor data.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a processor configured to retrieve a sensor data, wherein the sensor data comprises one or more signals communicated from a plurality of sensors disposed in a power production system. The processor is further configured to group the sensor data into one or more bins of data based on a degradation measure. The processor is also configured to quantify uncertainty in the one or more bins of data, wherein the uncertainty comprises a function of the difference between the one or more bins of data and a corrected data variation inference.

In a second embodiment, a method includes retrieving, via a processor, a sensor data, wherein the sensor data comprises one or more signals communicated from a plurality of sensors disposed in a power production system. The method further includes grouping, via the processor, the sensor data into one or more bins of data based on a degradation measure. The method additionally includes quantifying, via the processor, an uncertainty in the one or more bins of data, wherein the uncertainty comprises a difference between the one or more bins of data and a corrected data variation inference.

In a third embodiment, or more tangible, non-transitory, machine-readable media comprise instructions configured to cause a processor to retrieve a sensor data, wherein the sensor data comprises one or more signals communicated from a plurality of sensors disposed in a power production system. The instructions are further configured to cause the processor to group the sensor data into one or more bins of data based on a degradation measure. The instructions are additionally configured to cause the processor to quantify an uncertainty in the one or more bins of data, wherein the uncertainty comprises a difference between the one or more bins of data and a corrected data variation inference.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a power production system having a gas turbine system;

FIG. 2 is a flowchart of an embodiment of a process suitable for deriving an uncertainty from sensor data for the power production system of FIG. 1 and propagating the uncertainty to derive an improved sensor data; and

FIG. 3 is a flowchart of an embodiment of a process using an optimization engine to derive the uncertainty of FIG. 2.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed towards systems and methods for improving turbomachinery operations, including improving control of turbomachinery, via uncertainty quantification techniques. The turbomachinery may include gas turbine systems, steam turbine systems, hydro turbine systems, and the like. In certain embodiments, sensor data uncertainty may be quantified via the techniques disclosed herein and the quantification may be used, for example, to improve certain performance estimations (e.g., compressor efficiency estimation, gas turbine efficiency estimation, steam turbine efficiency estimation, heat recovery system generator (HRSG) efficiency estimation, and so on). The improved performance estimations may then be applied to provide for improved control, maintenance, and/or increased life of the turbomachinery.

In one embodiment, sensor data may be filtered or preprocessed to satisfy some conditions that may include but are not limited to steady state operations, base load operation, as well filters on the value of certain parameters (e.g., data smoothers, estimators, or any kind of data preprocessing that may aid in increasing data quality or eliminate spurious readings such as outliers. Filtered data may then clustered or binned by applying a certain similarity metric and the variation of between the filtered data may then be inferred for each cluster. The clustered data may then be processed via a physics-based model that may then output predictions for turbomachinery performance given certain site operations, ambient conditions, and so on. A penalty function may be derived from the physics-based model predictions, the sensor data and other variables that may include but are not limited to turbomachinery configuration.

In one embodiment, the penalty function may include a squared sum of weighted differences (sensor data—predicted data) of all the points in the cluster, or in general, a function of any subset (called a representative subset) of points in the cluster, where the subset of points may be selected with automatic procedures aimed at detecting the most representative points of the bin (the points that offer more information about the cluster). This subset can be obtained with statistical procedures such as ellipsoidal methods, m-estimates, l-estimates, scale and position estimators, averages, weighted averages, and so on. An optimization engine may then vary performance parameters (e.g., fuel type, fluid flow rates, temperatures, pressures, and so on) to minimize the penalty function and the optimization engine may also decide when to stop iterating based on certain optimization criteria that may include maximum number of iterations, a threshold in the penalty function, and/or a threshold as created as a function of the penalty function and the number of iterations (e.g., such as a decrease rate of the penalty function). An optimal state derived via the optimization engine may then be propagated to the original sensor data to derive a deviation measure of each individual point, to the optimal state of the bin or to a more optimal state of the bin. Differences between actual sensor data and predictions of the model assuming that all the individual points have the same optimal state may be considered to be a measure of instantaneous sensor error and other unmodeled effects (i.e. variations in parameters that may not be measured or in general any effects unaccounted by the modeling process) for a given point. An inference may then be made from the deviation measure to capture an underlying distribution of error and other unmodeled effects in sensors, and this distribution may then be propagated into an uncertainty of the optimal state estimation. In one embodiment, a Jacobian is used to linearly propagate the uncertainty to the performance parameters, but any propagation technique can be used, such as Montecarlo simulations, analytical solution of uncertainty propagation, maximum likelihood estimation based-methods, and any probabilistic method that can propagate uncertainties through any kind of deterministic or probabilistic transfer function. The output of this process is bin representative optimal state or a bin representative more optimal state with an associated uncertainty, or in a wider sense, a probabilistic characterization of the state given the data supplied to the optimization engine. The state may then be used, for example, to improve control of the turbomachinery, to better schedule maintenance of the turbomachinery, and/or to improve the life of the turbomachinery.

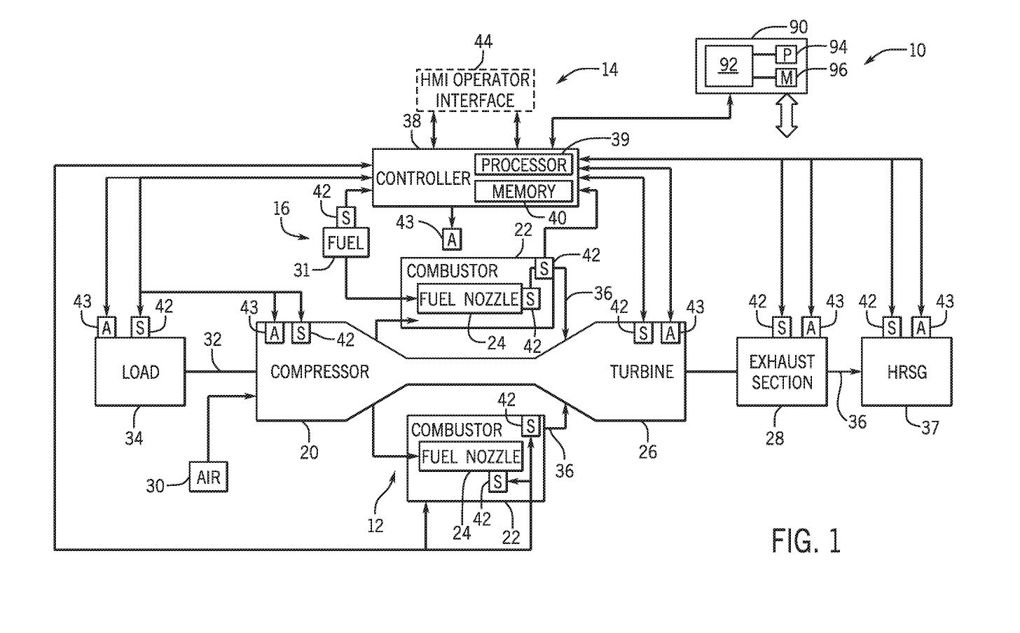

With the foregoing in mind, it may be useful to describe an embodiment of a turbomachinery incorporating techniques disclosed herein, such as a power production system 10 illustrated in FIG. 1. As illustrated in FIG. 1, the power production system 10 includes the gas turbine system 12, a monitoring and control system 14, and a fuel supply system 16. The gas turbine system 12 may include a compressor 20, combustion systems 22, fuel nozzles 24, a gas turbine 26, and an exhaust section 28. During operation, the gas turbine system 12 may pull air 30 into the compressor 20, which may then compress the air 30 and move the air 30 to the combustion system 22 (e.g., which may include a number of combustors). In the combustion system 22, the fuel nozzle 24 (or a number of fuel nozzles 24) may inject fuel that mixes with the compressed air 30 to create, for example, an air-fuel mixture.

The air-fuel mixture may combust in the combustion system 22 to generate hot combustion gases, which flow downstream into the turbine 26 to drive one or more turbine stages. For example, the combustion gases may move through the turbine 26 to drive one or more stages of turbine blades, which may in turn drive rotation of a shaft 32. The shaft 32 may connect to a load 34, such as a generator that uses the torque of the shaft 32 to produce electricity. After passing through the turbine 26, the hot combustion gases may vent as exhaust gases 36 into the environment by way of the exhaust section 28. The exhaust gas 36 may include gases such as carbon dioxide (CO₂), carbon monoxide (CO), nitrogen oxides (NOₓ), and so forth.

The exhaust gas 36 may include thermal energy, and the thermal energy may be recovered by a heat recovery steam generation (HRSG) system 37. In combined cycle systems, such as the power production system 10, hot exhaust 36 may flow from the gas turbine 26 and pass to the HRSG 37, where it may be used to generate high-pressure, high-temperature steam 50. The steam 50 produced by the HRSG 37 may then be passed through the steam turbine system 41 for further power generation. In addition, the produced steam may also be supplied to any other processes where steam may be used, such as to a gasifier used to combust the fuel to produce the untreated syngas. The gas turbine engine generation cycle is often referred to as the “topping cycle,” whereas the steam turbine engine generation cycle is often referred to as the “bottoming cycle.” Combining these two cycles may lead to greater efficiencies in both cycles. In particular, exhaust heat from the topping cycle may be captured and used to generate steam for use in the bottoming cycle.

In certain embodiments, the power production system 10 may also include a controller 38. The controller 38 may be communicatively coupled to a number of sensors 42, a human machine interface (HMI) operator interface 44, and one or more actuators 43 suitable for controlling components of the system 10. The actuators 43 may include valves, switches, positioners, pumps, and the like, suitable for controlling the various components of the system 10. The controller 38 may receive data from the sensors 42, and may be used to control the compressor 20, the combustors 22, the turbine 26, the exhaust section 28, the load 34, the HRSG 37, the steam turbine system 41, and so forth.

In certain embodiments, the HMI operator interface 44 may be executable by one or more computer systems of the power production system 10. A plant operator may interface with the power production system 10 via the HMI operator interface 44. Accordingly, the HMI operator interface 44 may include various input and output devices (e.g., mouse, keyboard, monitor, touch screen, or other suitable input and/or output device) such that the plant operator may provide commands (e.g., control and/or operational commands) to the controller 38. Further, operational information from the controller 38 and/or the sensors 42 may be presented via the HMI operator interface 44. Similarly, the controller 38 may be responsible for controlling one or more final control elements coupled to the components (e.g., the compressor 20, the turbine 26, the combustors 22, the load 34, and so forth) of the industrial system 10 such as, for example, one or more actuators 43, transducers, and so forth.

In certain embodiments, the sensors 42 may be any of various sensor types useful in providing various operational data to the controller 38. For example, the sensors 42 may provide flow, pressure, and temperature of the compressor 20, speed and temperature of the turbine 26, vibration of the compressor 20 and the turbine 26, as well as flow for the exhaust gas 36, temperature, pressure and emission (e.g., CO₂, NOx) levels in the exhaust gas 36, carbon content in the fuel 31, temperature of the fuel 31, temperature, pressure, clearance of the compressor 20 and the turbine 26 (e.g., distance between the rotating and stationary parts of the compressor 20, between the rotating and stationary parts of the turbine 26, and/or between other stationary and rotating components), flame temperature or intensity, vibration, combustion dynamics (e.g., fluctuations in pressure, flame intensity, and so forth), load data from load 34, output power from the turbine 26, and so forth. The sensors 42 may also include temperature sensors such as thermocouples, thermistors, and the like, disposed in the steam turbine system 41. The sensors 42 may also include flow sensors such as flowmeters (e.g., differential pressure flowmeters, velocity flowmeters, mass flowmeters, positive displacement flowmeters, open channel flowmeters) and liquid level sensors such as continuous level transmitters, ultrasonic transducers, laser level transmitters, and so on, disposed in the steam turbine system 41. Additionally, the sensors 42 may include pressure sensors such as piezo-resistive pressure sensors, differential pressure sensors, optical pressure sensors, and so on, included in the steam turbine system 41. Actuators 43 may include pumps, valves, linear actuators, switches, and the like.

The controller 38 may include a processor(s) 39 (e.g., a microprocessor(s)) that may execute software programs to control the power production system 10. Moreover, the processor 39 may include multiple microprocessors, one or more “general-purpose” microprocessors, one or more special-purpose microprocessors, and/or one or more application specific integrated circuits (ASICS), or some combination thereof. For example, the processor 39 may include one or more reduced instruction set (RISC) processors. The controller 38 may include a memory device 40 that may store information such as control software, look up tables, configuration data, etc.

The memory device 40 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof). The memory device 40 may store a variety of information, which may be suitable for various purposes. For example, the memory device 40 may store machine-readable and/or processor-executable instructions (e.g., firmware or software) for the processor execution.

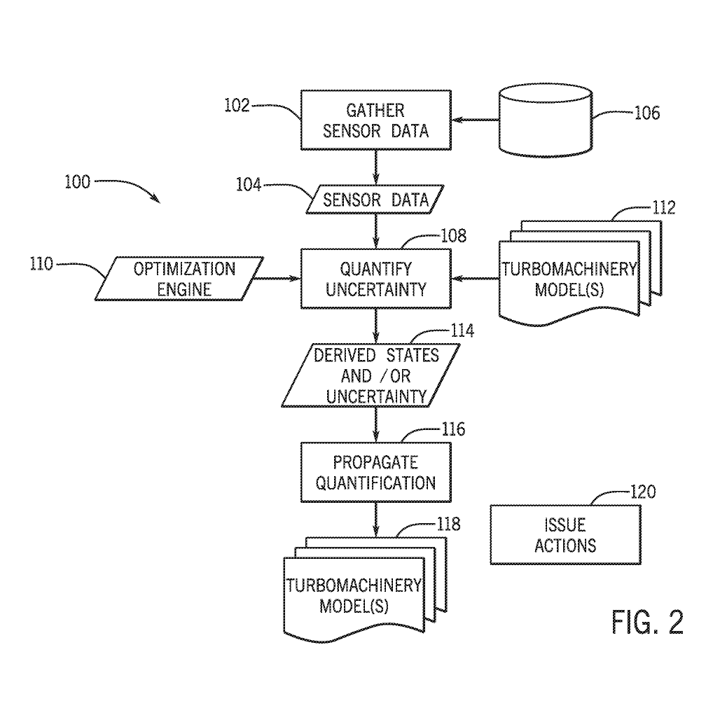

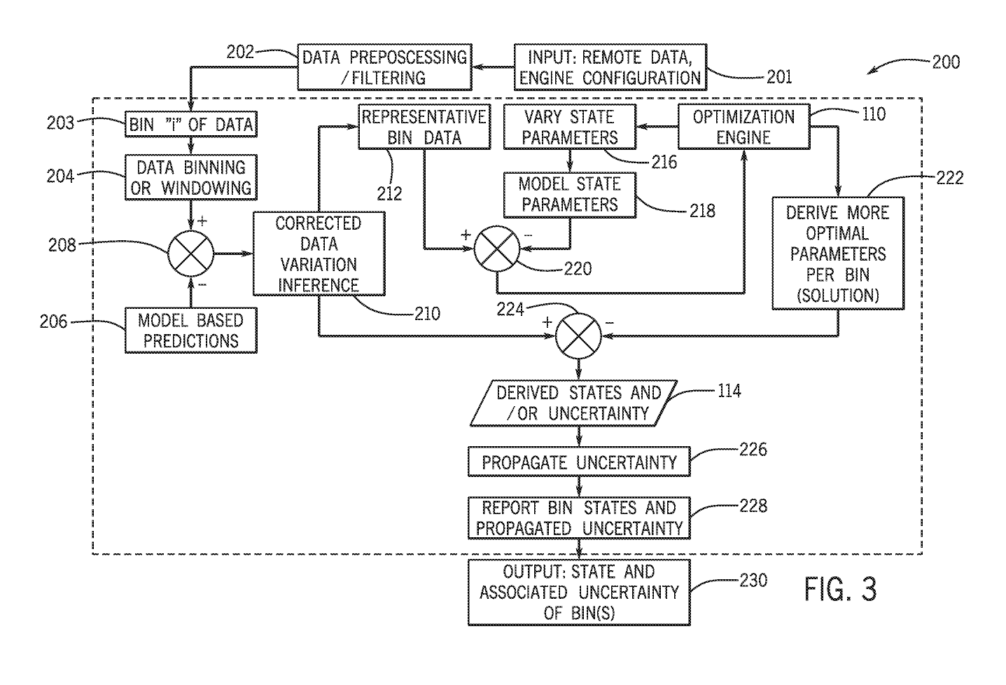

An analysis system 90 may be communicatively coupled to the controller 38, to the sensors 42, and/or actuators 43. The analysis system 90 may include one or more computing devices 92, each computing device 92 having one or more processors 94 and one or more memory devices 96. The processor(s) 94 may include multiple microprocessors, one or more “general-purpose” microprocessors, one or more special-purpose microprocessors, and/or one or more application specific integrated circuits (ASICS), or some combination thereof. For example, the processor 94 may include one or more reduced instruction set (RISC) processors. The processor(s) 39 and/or 94 may be used to execute certain of the techniques described herein, such as the processes illustrated in FIGS. 2 and 3.

The memory device 96 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof). The memory device 96 may store a variety of information, which may be suitable for various purposes. For example, the memory device 96 may store machine-readable and/or processor-executable instructions (e.g., firmware or software) for the processor execution.

During operations of the power production system 10 and/or operations of systems or components of the power production system 10 (e.g., gas turbine 12, steam turbine 41, HRSG 37, load 34) any estimation, forecast or prediction, for example, derived via the controller 38 may be sensitive to sensor 42 errors. For example, the controller 38 may use model based control (MBC) that receives as input data from the sensors 42 to then execute one or more models of various systems or components of the power production system 10 (e.g., gas turbine 12, steam turbine 41, HRSG 37, load 34) and derive certain reference points that may then be used to actuate the actuators 43 to control the power production system 10. However, sensor 42 errors have the potential to make the derivations inaccurate. The techniques described herein overcome some of the limitations of having measurement or sensor errors by characterizing the error and seeing the effect of that error in actual results (as opposes to predictions). The errors may then be minimized or eliminated as described in more detail below, thus improving power production system 10 performance evaluations, forecasts, predictions and/or optimizations.

FIG. 2 is a flowchart of an embodiment of a process 100 suitable for deriving certain sensor 42 measurement uncertainty and for quantifying and propagating the uncertainty in order to characterize sensor 42 measurement errors. The process 100 may be implemented as executable code instructions stored on anon-transitory tangible computer-readable medium, such as the volatile or non-volatile memory of a computer or a computer system, such as the memories 40 and/or 96, and may be executed via the processors 39 and/or 94. In one embodiment of the invention, the data may be transmitted to a remote location, such as system 90, stored and then code may be by a remote monitoring system 90.

In the depicted embodiment, the process 100 may gather (block 102) sensor data 104. For example, data from the sensors 42 may be collected via a data log database 106 and/or from the controller 38. The sensor data 104 may include data from all the sensors 42 or a subset of the sensors 42. Accordingly, the data may include measurements such as temperatures, pressures, fluid flows, speeds, clearances (e.g., distances between moving and stationary components), ambient or environmental measurements (e.g., humidity, atmospheric pressure, temperature), and so on.

The process 100 may then quantify (block 108) uncertainty in the sensor data 104. For example and as described in more detail below with respect to FIG. 3, the process 100 may execute an optimization engine 110 which may use certain models, such as turbomachinery models 112, to derive expected values incoming form the sensors 42, and apply those expected values to derive certain states and/or an uncertainty 114. The models 112 may include physics-based models such as such as low cycle fatigue (LCF) life prediction models, computational fluid dynamics (CFD) models, thermodynamic models, finite element analysis (FEA) models, solid models (e.g., parametric and non-parametric modeling), and/or 3-dimension to 2-dimension FEA mapping models that may be used to predict the performance equipment or components (e.g., combustor efficiency, gas turbine efficiency, steam turbine efficiency, shaft speeds, temperatures, pressures, fluid flows, and so on). Models 112 may also include artificial intelligence (AI) models, such as expert systems (e.g. forward chained expert systems, backward chained expert systems), neural networks, fuzzy logic systems, state vector machines (SVMs), inductive reasoning systems, Bayesian inference systems, or a combination thereof.

The derived states and/or uncertainty 114 may then be propagated (block 116). For example, the states and/or uncertainty 114 may be used to provide quantified turbomachinery models 118 that include the states and/or uncertainty 114 or that use the states and/or uncertainty 114 as input to derive various estimations, forecasts or predictions, suitable to then issue (block 120) (e.g., via the controller 38) as actions. The actions issued may include control actions, such that the controller 38 may actuate the various actuators 43 to control the power production system 10, and/or systems and components of the power production system 10. The actions issued may also include maintenance actions, such as requests to service certain systems and components of the power production system 10.

Turning now to FIG. 3, the figure is a flowchart of an embodiment of a process 200 suitable for deriving certain states and/or uncertainties 114 from sensor data 104. The process 200 may be implemented as executable code instructions stored on a non-transitory tangible computer-readable medium, such as the volatile or non-volatile memory of a computer or a computer system, such as the memories 40 and/or 96, and may be executed via the processors 39 and/or 94.

In the depicted embodiment, inputs 201 may include the sensor data 104 as well as certain equipment configuration, such as a configuration for the gas turbine system 12 (e.g., fuel nozzles, combustors, electrical generators, type of the components such as a dry low emission [DLE] combustor, can combustor, cannular combustor, annular combustor, etc., age of the components [e.g., in fired hours, calendar hours, etc., type of fuel, and so on). The inputs 201 may be preprocessed or filtered (block 202). The preprocessing (block 202) may insure, for example, that the data 104 is only for certain operations, such as for startup, baseload, partial load, shutdown, trip, or so on, of the gas turbine system 12 and/or any other system or component of the power production system 10. The filtering (block 202) may remove outliers in the data, such as negative points in data that should only include positive values, values outside certain ranges, and so on.

The process 200 may then apply a data binning or clustering (block 204), for example, based on a time measure that minimizes the amount of degradation. More specifically, the process 200 may group data to account for a degradation measure such as a given time range (e.g., between 1 hour and 1 week, 1 week and 1 month, 1 month and 1 year) so that during the grouped time range the data in the group has approximately the same amount of degradation. Degradation measures may include number of fired hours, operating hours, calendar hours, and so on. Degradation measures may alternatively or additionally include corrosion measures, wear measures, and so on. By removing degradation, the data's uncertainty may not be influenced by components degrading over time. It is to be noted that the time range may be in fired hours, in calendar hours, in operating hours, and so on.

The process 200 may then execute (block 206) one or more models, such as the models 112 described with respect to FIG. 2, to predict or otherwise derive certain performance parameters for the configuration of the equipment found in the input 201. For example, given a baseload for the gas turbine system 12, the models 112 may predict (block 206) power production in megawatts, temperatures, speeds, pressures, fluid flows, clearances, and so on. Predictions from the models 112 may be slightly “off” when compared to the data that has been binned in block 204. That is, there may be certain residuals (e.g., difference between model-based predictions of block 206 and data found via the binning of block 204). These residuals may be identified via a difference analysis (block 208), and then used to correct (block 210) some of the data binned through block 204.

For example, the binned data may include a certain noise, biases, and so on, that may be inferred via block 210. As an example using megawatts, if the model(s) 112 predict (block 206) the following series of data points: 99, 100, 101, 102, and the binned data includes respective data points 100, 101, 102, 103, then the block 210 may infer that a variation of +1 is found for this simple example. Techniques such as averaging, linear regression, non-linear regression, statistical distribution analysis, and so on, may be used to infer (block 210) variation in the binned data.

A representative bin data 212 may then be derived based on corrected data variation inferencing (block 210). The representative bin data 212 may include data that is closer or more representative of the data derived via the model based predictions (block 206). For example, the representative bin data 212 may include residual values having minimal values, or even zero values. As illustrated, the representative bin data 212 is typically a subset of all data binned via block 204. By reducing the amount of data analyzed, faster processing may be provided.

The optimization engine 110 may then be executed via the process 200 to derive certain states. More specifically, the optimization engine 110 may include a penalty function that may be derived from model 112 predictions. In one embodiment, the penalty function may include a squared sum of weighted differences (e.g., differences between sensor data and model predicted data) of all the points in the bin or cluster, or in general, a function of any subset (called a representative subset) of points in the cluster, where the subset of points may be selected with automatic procedures aimed at detecting the most representative points of the bin (the points that offer more information about the cluster). This subset can be obtained with statistical procedures such as ellipsoidal methods, m-estimates, l-estimates, scale and position estimators, averages, weighted averages, and so on derived via block 204. The optimization engine 110 may then vary (block 216) state or performance parameters (e.g., airflow, fuel flow, fluid flow rates, temperatures, pressures, clearances, and so on) to minimize the penalty function. The parameters varied (block 216) by the optimization engine 110 may then be used to derive (block 218) model based predictions, for example, using the model(s) 112. The derivation from block 218 may be compared via a differentiator 220 with the representative bin data 212 and reported back to the optimization engine 110.

The optimization engine 110 may iterate for one or more iterations and then decide to stop iterating based on certain optimization criteria. The optimization criteria may include a maximum number of iterations, going over or under a threshold in the penalty function, and/or going over/under a threshold created as a function of the penalty function and the number of iterations (e.g., such as a decrease rate of the penalty function). Once the optimization engine 110 stops iterations, the state parameters used by the block 216 during the final iteration may be used to derive (block 222) bin representative optimal predictions (or more optimal predictions) for each bin analyzed. For example, the state parameters found in block 216 during the last iteration (e.g., airflow, fuel flow, fluid flow rates, temperatures, pressures, clearances, and so on) may be used to predict compressor efficiency (e.g., isentropic efficiency), gas turbine efficiency (e.g., thermal efficiency), exhaust flow rates, speed of the gas turbine, and/or similar measures for the HRSG 37 the steam turbine 41, and the load 34.

The states and uncertainty 114 may be derived by comparing the representative optimal bin state (or more optimal bin state) derived parameters per bin from block 222 with the corrected data variation inference 210, for example, via a differentiator 224. For example, the uncertainty 114 may include a difference between bin data and the corrected data variation inference 210. More specifically, values derived via the block 222 may be compared to actual bin values (e.g., corrected data 210) and differences observed may be stored as the states and uncertainties of the states 114.

The derived states and uncertainties 114 may then be propagated (block 226). For example, a Jacobian (e.g., Jacobian matrix of all first order partial derivatives of a vector valued function) may be used to linearly propagate the uncertainty to the performance parameters (e.g., combustor efficiency, gas turbine efficiency, steam turbine efficiency, HRSG efficiency) but any propagation technique can be used, such as Montecarlo simulations. The process 200 may then report (block 228) the propagation, for example, the process 200 may provide the states and uncertainty 114 to other systems such as the controller 38, to be used for control of the power production system 10, and/or systems and components of the power production system 10. Accordingly, an output block 230 is depicted, which may include the states and uncertainty 114.

Technical effects of the invention include the ability to quantify uncertainty in sensor data by using bin groupings. The sensors may be disposed in various systems and components of a power production system, such as a gas turbine power production system. The bin groups may be derived via degradation measures. An optimization engine may then be used to iterate through various bins to derive an uncertainty for each bin, and then the uncertainty may be quantified and propagated. The propagated uncertainty may then be used to improve control, maintenance, and/or design of the power production system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a processor configured to:
retrieve a sensor data, wherein the sensor data comprises one or more signals communicated from a plurality of sensors disposed in a power production system;
group the sensor data into one or more bins of data based on a degradation measure; and
quantify uncertainty in the one or more bins of data, wherein the uncertainty comprises a function of the difference between the one or more bins of data and a corrected data variation inference.

2. The system of claim 1, wherein processor is configured to propagate the uncertainty to one or more performance parameters.

3. The system of claim 2, wherein the processor is configured to propagate the uncertainty via a Jacobian matrix, a Montecarlo simulation, or a combination, thereof.

4. The system of claim 2, wherein the performance parameters comprise a compressor efficiency, a gas turbine efficiency, a steam turbine efficiency, a heat recovery steam generator (HRSG) efficiency, or a combination thereof.

5. The system of claim 2, wherein the processor is configured to control the power production system based on the one or more performance parameters.

6. The system of claim 1, wherein processor is configured to derive the corrected data variation inference by executing a model of the power production system with the one or more bins of data as input and by comparing an output of the model with the one or more bins of data.

7. The system of claim 1, wherein the processor is configured to execute an optimization engine to derive the uncertainty, and wherein the optimization engine is configured to take as input a comparison between a representative bin data and a model-predicted value, wherein the model-predicted value is derived by applying a predicted performance parameter to a model of the power production system.

8. The system of claim 7, wherein the model comprises a physics-based model of the power production system configured to derive the predicted performance parameter via thermodynamics, computational fluid dynamics, or a combination thereof.

9. The system of claim 7, wherein the optimization engine is configured to iterate to derive the uncertainty by varying at least one state parameter at each iteration.

10. The system of claim 9, wherein the optimization engine is configured to stop iteration based on reaching a maximum number of iterations, going over or going under a threshold value, going over or going under a penalty function value, or a combination thereof.

11. The system of claim 1, wherein the power production system comprises a gas turbine, a steam turbine, a heat recovery steam generator (HRSG), or a combination thereof.

12. A method comprising:
retrieving, via a processor, a sensor data, wherein the sensor data comprises one or more signals communicated from a plurality of sensors disposed in a power production system;
grouping, via the processor, the sensor data into one or more bins of data based on a degradation measure; and
quantifying, via the processor, an uncertainty in the one or more bins of data, wherein the uncertainty comprises a difference between the one or more bins of data and a corrected data variation inference.

13. The method of claim 12, comprising propagating, via the processor, the uncertainty to one or more performance parameters.

14. The method of claim 12, comprising deriving, via the processor, the corrected data variation inference by executing a model of the power production system with the one or more bins of data as input and by comparing an output of the model with the one or more bins of data.

15. The method of claim 14, comprising grouping, via the processor, the sensor data into at least two of the one or more bins of data, and quantifying uncertainties for the at least two of the one or more bins of data.

16. The method of claim 12, comprising executing, via the processor, an optimization engine to derive the uncertainty, and wherein the optimization engine is configured to take as input a comparison between a representative bin data and a model-predicted value, wherein the model-predicted value is derived by applying a predicted performance parameter to a model of the power production system.

17. One or more tangible, non-transitory, machine-readable media comprising instructions configured to cause a processor to:
retrieve a sensor data, wherein the sensor data comprises one or more signals communicated from a plurality of sensors disposed in a power production system;
group the sensor data into one or more bins of data based on a degradation measure; and
quantify an uncertainty in the one or more bins of data, wherein the uncertainty comprises a difference between the one or more bins of data and a corrected data variation inference.

18. The one or more tangible, non-transitory, machine-readable media of claim 17, comprising instructions configured to cause the processor to propagate the uncertainty to one or more performance parameters.

19. The one or more tangible, non-transitory, machine-readable media of claim 17, comprising instructions configured to cause the processor to execute an optimization engine to derive the uncertainty, and wherein the optimization engine is configured to take as input a comparison between a representative bin data and a model-predicted value, wherein the model-predicted value is derived by applying a predicted performance parameter to a model of the power production system.

20. The one or more tangible, non-transitory, machine-readable media of claim 17, comprising instructions configured to cause the processor to iterate to derive the uncertainty by varying a state parameter at each iteration.
